(19) United States
(12) Patent Application Publication
(10) Pub. No.: US 2005/0062184 A1
(43) Pub. Date: Mar. 24, 2005

(54) Process for preparing a crosslinked polyolefin foam

(75) Inventors: Michel Ladang, Battice (BE); Dominique Petit, Blegny (BE)

Correspondence Address: OBLON, SPIVAK, MCCLELLAND, MAIER & NEUSTADT, P.C., 1940 DUKE STREET, ALEXANDRIA, VA, 22314, US

(73) Assignee: NORTON PERFORMANCE PLASTICS, Chaineux (BE)

(21) Appl. No.: 10/983,630

(22) Filed: Nov. 9, 2004

Related U.S. Application Data
(63) Continuation of application No. 09/580,874, filed on May 30, 2000.
Application No. 09/580,874 is a continuation of application No. 09/405,231, filed on Sep. 24, 1999, now abandoned.

(30) Foreign Application Priority Data
Sep. 24, 1998 (FR) 98 11913

(51) Int. Cl. B29C 44/02

(52) U.S. Cl. 264/51

(57) ABSTRACT

The process of the invention is characterized by the unidirectional expansion of a composition containing a substantial proportion of at least partially crosslinked and/or crosslinkable polyolefin, in order to form a product made of foam, especially relatively compliant foam. The use of a polyethylene or ethylene copolymer obtained by metallocene catalysis is preferred.

The present invention relates to the preparation of crosslinked foams such as those consisting of polyolefins.

Crosslinked polyolefin foams are flexible foams having relatively low densities, generally less than 200 kg/m³, and the solid phase of which essentially consists of crosslinked polyolefins. The polyolefins most usually employed in this field are polyethylene (PE), polypropylene (PP) and ethylene/vinyl acetate copolymer (EVA).

Crosslinking allows the foams to be improved on many points regarding their mechanical and thermal properties; finer cellular structures are obtained.

The crosslinking may consist of high-energy irradiation, such as by an electron beam, or of a chemical reaction with agents of the peroxide type or with moisture by the incorporation of a silane side group into the backbone of the polyolefin. In the first two processes mentioned, reactive sites with free radicals are created on the carbon chains of the polyolefin molecules, for the purpose of subsequently forming intermolecular crosslinking bonds.

In the third process (crosslinking using moisture), the crosslinking is achieved by forming polyolefin-Si—O—Si-polyolefin intermolecular bonds.

Crosslinking using high-energy irradiation is noteworthy in its ability to produce perfectly uniform crosslinking in the surface; it allows high-quality foam sheets with a thickness as little as 0.2 mm to be manufactured.

The situation is the reverse in the case of chemical crosslinking by peroxides or with other agents and for silane crosslinking, which processes are recommended for sheets having greater thickness, for example between 3 and 18 mm, since in these processes the crosslinking takes place throughout the thickness of the product in a homogeneous and uniform manner. On the other hand, these processes are much less suitable for very thin sheets since, on the microscopic scale, the dispersion of the crosslinking agents is less homogeneous than that which can be obtained by means of an electron beam.

Moreover, the expansion of crosslinked polyolefin foams occurs in three dimensions. It is important for the degree of crosslinking of the resin both at the start of the expansion and throughout its duration to be carefully controlled; the initial content of the compositions in terms of blowing agent and of crosslinking agent (in the case of chemical crosslinking) is, of course, tailored to this effect, as are the durations and temperatures of the heat treatments. However, whatever the operating conditions thus selected, the product is in the liquid-solid transition state during the combined crosslinking and expansion; it is tacky, difficult to handle or even runny, in which case it is liable to conform to the surface of the oven against which it rests by adhering thereto, free expansion then being prevented, which, finally, is to the detriment of the surface appearance of the product obtained (presence of irregularities in streaks, wrinkles, etc.).

Various techniques have been proposed for carrying out, especially continuously, the three-dimensional expansion-crosslinking of relatively fluid, tacky intermediate products.

A first technique consists in making the product float on a heated bath consisting of 50% KNO₃ and 50% NaNO₂ (the Toray process). The bath, heated to the expansion temperature, has the consistency of a hot oil and the expansion develops freely in the three dimensions. The final foam conforms to the flat surface of the bath; its manufacture is completed by washing, drying and, if required, winding operations.

According to a second proposal (the Toray and Sekisui process), a vertical oven, preceded by a horizontal oven for preheating/conditioning (at a temperature below the expansion temperature), is used. The product, for example in the form of a continuous sheet, is drawn upwards by means of pull rolls; the vertical oven produces a countercurrent of hot air and infrared radiation. The means for holding the resin in the vertical oven are designed in accordance with the three-dimensional expansion: in particular, they include drive rolls having speeds which increase from the upstream to the downstream end.

However, a third approach is more frequent than the first two. This is the approach of the Hitachi and Furukawa processes, using a horizontal oven having three zones of gradual heating. In the three zones, are operations of precrosslinking/conditioning to a temperature below the decomposition temperature of the blowing agent, of a first expansion phase at a moderate temperature and then of a second phase for completing the expansion at a higher temperature are carried out, respectively. In order to prevent the relatively tacky intermediate product from adhering to its support so as subsequently to disturb the development of the expansion, this support possibly consists, in places, of air cushions.

The three processes are quite flexible to use, multipurpose and, in particular, compatible with crosslinking by irradiation, chemical crosslinking or crosslinking by silane condensation. Nevertheless, the fact remains that they are complex and expensive in terms of equipment.

Moreover, the crosslinking polyolefin foams known at the present time are relatively hard.

There is therefore a need to have a simple and inexpensive process for preparing a foam as mentioned above, which gets round the problem of flow and adhesion of the resin to its support during the preparation and the driving of the expanding product, the foam thus obtained additionally having novel properties.

This objective is achieved by the invention, whose subject is a process for preparing a crosslinked polyolefin foam, consisting partly or in its entirety of an essentially unidirectional expansion.

By thus blocking the expansion in two of the three dimensions and, in particular, in the direction in which the material is driven, this driving is considerably facilitated in a continuous production operation. The driving no longer has to be carried out at a speed which increases from the upstream to the downstream end, as explained above, and the positioning of the driving members may vary only in the driving direction and no longer has to be adjusted in other directions as the expansion progresses. The use of a bath requiring lengthy washing and drying operations is superfluous.

The process of the invention is particularly well suited to the expansion of a product having substantially the shape of a sheet, the expansion being only in its thickness.

According to another advantageous characteristic with a view to an industrial production operation, the process is carried out continuously. In the preferred case of the abovementioned sheet, the latter then consists of a continuous web. This web comes from a wound roll or consists of an extruded product. A horizontal oven is then preferably used, especially of the type having three zones (the Hitachi and Furukawa processes mentioned above), generally in simplified versions without air cushions. This is because, as explained in detail below, the invention solves, to a large extent and in another manner, the problem of the product to be expanded adhering to the surface of the oven.

However, the use of a vertical oven (the Toray and Sekisui process) or even of a heated bath, as explained above, although not preferred in the context of the invention is in no way excluded therefrom, it being understood that suitable materials compatible with the characteristics of the process are chosen in the construction of the foam product to be prepared.

As already mentioned, the unidirectional expansion is carried out by blocking the expansion in the other two directions. Two main modes of blocking form a part of the invention.

According to a first mode, a support is made to adhere, prior to the expansion, to one or both faces of the intermediate product to be expanded, these being perpendicular to the direction of the expansion. The expansion in the directions lying in the plane of these faces is blocked by the effect of the adhesion to the support which is not extensible.

In the case of the expansion of a sheet, the supports are generally also a form of sheet. The adhesion of the support to one face of the product may be obtained in various ways.

Generally, the product to be expanded is subjected to gradual heating; the crosslinking usually starts before the expansion, although the invention in no way excludes the expansion taking place entirely afterwards, all the intermediate situations also being within the scope of the patent. The aim of making the crosslinking start before the expansion is to increase the viscosity of the intermediate product and, more specifically, to prevent its viscosity being too low at the moment when the blowing agent decomposes or the blowing gas is released, in which case the foam obviously does not form.

At a given moment before the expansion, the product is usually in a tacky, or even runny, state, especially due to the effect of an increase in temperature. The adhesion of the support to one face of the intermediate product then simply results by applying one against the other.

This adhesion may also be easily obtained by coextrusion, for example in the production of a polyethylene foam on a poly(ethylene terephthalate) support.

Moreover, another variant consists in increasing the surface tension of the support, for example by trapping charges on its surface by corona discharge, and then bringing this surface of the support into contact with one face of the intermediate product. The support is capable of adhering to this product by an electrostatic effect.

The second main mode of blocking the expansion in two directions consists in surface-crosslinking beforehand one or both faces of the intermediate product to be expanded, these being perpendicular to the direction of the expansion. The three aforementioned types of crosslinking, by high-energy irradiation (electron beam,, etc.), chemical reaction with compounds such as peroxides, or with moisture by the incorporation of a silane into the polyolefin, may be employed here. The surface crosslinking therefore comprises one or more of the following steps:
high-energy irradiation;
spraying of reactants (water or another reactant);
application of light radiation or corona discharge, in order to form free radicals;
raising the temperature, carefully determined in terms of intensity and duration, etc.

The choice of whether one or both supports is present, or whether there is no support, and, in this case, the choice of surface crosslinking of one or both faces of the intermediate product, depends on many factors.

The two-support variant is well suited to a final product in the form of flat plates. On the other hand, the two-support variant makes it almost impossible to wind this product. In this variant, it may therefore be indicated to remove one of the supports if it is desired to present the final product in the form of rolls.

The use of the support results in denser foams than that having two supports. This is because the blowing alas is capable of escaping via the free surface of the product, that is to say the unsupported surface.

Moreover, the surface appearance of the product obtained may be chosen in a controlled manner depending on the envisaged application, this surface possibly consisting of a support or of the surface of the foam itself, optionally after removing one support.

The variant of the second main mode of blocking the expansion in two directions, consisting in surface-crosslinking one or both faces of the intermediate product before the expansion, makes it possible to produce, in a controlled manner, a foam whose degrees of surface crosslinking and core crosslinking are identical or different.

According to a preferred characteristic of the process of the invention, the foam is obtained from a composition comprising at least 20% by upright of a polyethylene or of an essentially linear ethylene copolymer of density of between 0.80 and 0.96 g/cm³.

Particularly preferably, the polyethylene or the ethylene copolymer used is obtained by metallocene catalysis and has a density of at most 0.92 g/cm³. With regard to the composition of these preferred polymers, and in particular their physical characteristics and the nature of the comonomers, Patent Application EP 0,702,032 A2, which also describes their treatment by crosslinking and expansion, is incorporated here by way of reference.

The example which follows serves to illustrate the invention.

### EXAMPLE

Crosslinked polyolefin foams are prepared from blends having the following polymers:
low-density polyethylene sold by Polimeri Europa under the registered trademark RIBLENE:
   [symbol] grade FL 20:
      density d=0.921 g/cm³,
      melt flow index (MFI)=2.2 g/10 min;
ethylene copolymer elastomers obtained by metallocene catalysis and sold by Du Pont/Dow Elastomers under the registered trademark ENGAGE:
   [symbol] grade 8400:
      d=0.870 g/cm³,
      MFI=30 g/10 min;
   [symbol] grade 8200:
      d=0.870 g/cm³,
      MFI=5 g/10 min;
ethylene/butene copolymer obtained by metallocene catalysis and sold by Exxon Chemical under the registered trademark EXACT:
   [symbol] grade 5008:
      d=0.865 g/cm³,
      MFI=10 g/10 min;
ethylene/vinyl acetate copolymer sold by Alochem under the registered trademark EVATANE:
   [symbol] grade 28-25:
      d=0.950 g/cm³,
      MFI=22-29 g/10 min
(the weight content of vinyl acetate is between 27 and 29%);
isobutylene/isoprene copolymer (butyl rubber) sold by Exxon Chemical under the name 268:
   d=0.920 g/cm³,
   Mooney viscosity ML 1+8 at 125° C.=51±5;
isobutylene/isoprene copolymer sold by Exxon Chemical under the name 065:
   d=0.9:20 g/cm³,
   Mooney viscosity ML 1+8 at 100° C.=45±4.

The densities are determined according to the ASTM D 1505 standard, the MFI to the ASTM D 1238 standard and the Mooney viscosity to the ASTM D 1646 standard.

A composition containing one or two of the aforementioned polymers is homogenized for 3 minutes. To this are added, over 40 seconds, a blowing agent in the usual proportion (approximately 30 g per 100 g of polymer). This blowing agent, sold by Tramaco under the name TRACEL XL 3139, is an azodicarbonamide (blowing agent) mixed with an organic peroxide (crosslinking agent), both being dispersed in a polyolefin. Its decomposition temperature is approximately 145° C.

The compound is mixed for 10 minutes in a Brabender mixer at a temperature of 125° C. and a speed of rotation of 60 rpm.

The product is removed and placed between two sheets of glass fabric completely impregnated with poly(tetrafluoroethylene). A composite film 2 mm in thickness is thus produced by means of a hydraulic press heated to 110° C.

The expansion is carried out by heating at 210° C. for 4 minutes 30 seconds to 5 minutes. Finally, the sheets of glass fabric are removed from the foam obtained.

Various tests were carried out on this foam:
measurement of the density (in kg/m³);
a compression C (in N/cm²) according to the ASTM D 1667 standard with a degree of compression of 30% and a rate of compression of 10 mm/minute;
deflection R (in N/cm²) (the compression is held at 30% for 1 minute);
water absorption (in % by weight);
compression set (in %):
   this percentage expresses a thickness reduction, measured after a specimen is compressed to 25% of its thickness for 22 hours at room temperature followed by resting for 24 hours at the same temperature.

The results are given in Table I below:

TABLE I

| | | | Water | Compression |
|---|---|---|---|---|
| | Density | C/R | absorption | set |
| Composition | (kg/m³) | (N/cm²) | (%) | (%) |
| EN 8400/RIBLENE | | | | |
| 100/0 | 120 | 2.53/1.95 | 22.20 | 6.66 |
| 70/30 | 103 | 2.44/1.46 | 48.11 | 11.62 |
| 50/50 | 102 | 6.38/4.31 | 30.60 | 8.50 |
| EN 8200/RIBLENE | | | | |
| 100/0 | 126 | 4.25/3.33 | 19.50 | 7.66 |
| 70/30 | 104 | 5.36/3.86 | | 6.66 |
| EX 5008/RIBLENE | | | | |
| 100/0 | 130 | 1.92/1.52 | 35.60 | 6.70 |
| 70/30 | 120 | 6.35/3.70 | 11.80 | 7.60 |

With:
EN = ENGAGE; EX = EXACT;
C = Compression; R = Deflection

The crosslinked polyolefin foams obtained are noteworthy by their compliance, as indicated by the value of C of between 1.92 and 6.38 N/cm² for densities≧102 kg/m³.

The foams have a fine structure and closed cells for the most part, as indicated by the relatively low amounts of absorbed water.

Their gel content, defined as the percentage by weight of the insoluble fraction—in the form of dry extract—of a 50 mg item immersed for 24 hours at 120° C. in 25 ml of xylene dried over a molecular sieve, is between 40 and 60% in all cases.

The foams can be applied in various fields, including the most demanding like the sealing market.

The structure of the foams is good, including that of their skin: the surface is smooth and has a beautiful appearance free of irregularities.

A second series of tests was carried out by replacing the RIBLENE low-density polyethylene (LDPE) with elastomeric products having lower molecular weights in this case the isobutylene/isoprene and ethylene/vinyl acetate copolymers mentioned above.

The results are given in Table II below.

TABLE II

| | Density | C/R | Thickness |
|---|---|---|---|
| Composition | (kg/m³) | (N/cm²) | (mm) |
| EN 8400/N27 | | | |
| 70/30 | 142 | 1.81/1.21 | 10.95 |
| 50/50 | 161 | 2.16/1.35 | 10.30 |
| EN 8400/065 | | | |
| 70/30 | 135 | 1.80/1.31 | 11.00 |
| EN 8400/EVA 2825 | | | |
| 70/30 | 137 | 2.70/2.15 | |

Although the expansion times were longer, between 5 minutes 30 seconds and 6 minutes, expansion took place to a lesser degree than with LDPE instead of an elastomer, as indicated by the relatively high densities ranging from 135 to 161 kg/m³.

The foams obtained are remarkably compliant (low compressions).

The cellular structure of the foam produced from butyl 065 is less fine than the others.

Compared with the first series of tests (Table I), the foams of the second series (Table II) have a thinner skin which is more fragile and adheres more strongly to the support.

Thus, a process is available, which is simplified mainly with regard to the equipment to be used, or the continuous preparation of a foam, in which the expansion of the product requires no complicated adaptation of the driving means. The problem of the flow and of the adhesion of the resin to the bottom of the oven is eliminated either by interposing one or two support sheets, such as sheets of PTFE-impregnated glass fabric in the above example, or by surface crosslinking.

In this way, remarkably compliant crosslinked polyolefin foams can in particular be obtained.

1-9. (Canceled).

10. A process for preparing a sheet of a crosslinked polyolefin foam expanded in an essentially unidirectional expansion only in its thickness, which comprises:
surface-crosslinking at least one face of an unsupported intermediate polyolefin sheet to be expanded so that its degree of surface crosslinking is different from its core,
wherein said at least one face is perpendicular to the direction of expansion; and
expanding and crosslinking the so formed sheet only in its thickness.

11. The process according to claim 10, carried out continuously.

12. The process according to claim 10, wherein the polyolefin foam comprises at least 20% by weight of a polyethylene or of an essentially linear ethylene copolymer having a density of 0.80 to 0.96 g/cm².

13. The process according to claim 12, wherein the polyethylene or ethylene copolymer is obtained by metallocene catalysis and has a density of at most 0.92 g/cm³.

14. A compliant crosslinked foam obtained by the process of claim 10.
